(19) United States
(12) Patent Application Publication
(10) Pub. No.: US 2025/0259620 A1
(43) Pub. Date: Aug. 14, 2025

(54) APPARATUSES AND METHODS FOR FACILITATING A TRANSCRIPT SUMMARIZATION WITH SPELLING CORRECTIONS

(71) Applicant: JPMorgan Chase Bank, N.A., New York, NY (US)

(72) Inventors: Peter Plantinga, Columbus, OH (US); Chandra Dhir, San Jose, CA (US); Naren Chittar, Saratoga, CA (US)

(73) Assignee: JPMorgan Chase Bank, N.A., New York, NY (US)

(21) Appl. No.: 18/439,788

(22) Filed: Feb. 13, 2024

(51) Int. Cl. G10L 15/01; G10L 15/06

(52) U.S. Cl. CPC G10L 15/01; G10L 15/063

(57) ABSTRACT

Aspects of the subject disclosure may include, for example, obtaining a model, obtaining input audio, processing the input audio to generate a transcript, obtaining at least one summary based on the transcript, identifying at least one error or inconsistency in the transcript or the at least one summary based on the model, and implementing, based on the identifying, a correction or a clarification in respect of the at least one error or inconsistency. Other aspects are disclosed.

### FIELD OF THE DISCLOSURE

The subject disclosure relates to apparatuses and methods for facilitating a transcript summarization with spelling corrections.

### BACKGROUND

As the world increasingly becomes connected via vast communication networks and systems and via various types/kinds of communication devices, additional opportunities are created/generated to provision services and applications that provide for a wide range of functionalities and capabilities. Artificial intelligence and machine learning are two technologies that have witnessed tremendous growth in recent years. Users may interface with such technologies to enhance productive capabilities/outputs in relation to services and applications.

In the context of communications (e.g., audio, voice, video, videoconferencing, meetings, etc.), in many instances or scenarios users may desire a transcript of the communications (e.g., discussion) to be generated for a variety of purposes, such as generating a record, reviewing the record, analyzing the record for quality purposes, etc. While generally effective, a use of speech-to-text technologies in generating a transcript may introduce errors or inconsistencies. For example, names of users partaking in a conversation (e.g., a meeting) may be misspelled, and these misspellings may be reproduced by, e.g., a summarization system. Conventional speech-to-text and summarization systems/technologies lack relevant context or awareness to reliably identify/recognize, much less correct, such errors and inconsistencies.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system for generating clarifications to summaries in accordance with various aspects described herein.

FIG. 2 depicts an illustrative embodiment of a method in accordance with various aspects described herein.

FIG. 3 is a block diagram of an example, non-limiting embodiment of a computing environment in accordance with various aspects described herein.

### DETAILED DESCRIPTION

The subject disclosure describes, among other things, illustrative embodiments for generating transcripts and summaries, inclusive of a capability to auto-correct errors or inconsistencies. Other embodiments are described in the subject disclosure.

One or more aspects of the subject disclosure may include, in whole or in part, obtaining a model; obtaining input audio; processing the input audio to generate a transcript; obtaining at least one summary based on the transcript; identifying at least one error or inconsistency in the transcript or the at least one summary based on the model; and implementing, based on the identifying, a correction or a clarification in respect of the at least one error or inconsistency.

One or more aspects of the subject disclosure may include, in whole or in part, obtaining audio; processing the audio to generate a transcript; obtaining at least one summary based on the transcript; identifying at least one error in the at least one summary based on a model; and implementing, based on the identifying, a correction in respect of the at least one error.

One or more aspects of the subject disclosure may include, in whole or in part, obtaining, by a processing system including a processor, audio; processing, by the processing system, the audio to generate a transcript; identifying, by the processing system, at least one error in the transcript based on a model and data obtained from a plurality of sources; and implementing, by the processing system and based on the identifying, at least one correction in respect of the at least one error.

By way of introduction, aspects of this disclosure may utilize speech-to-text technologies to generate a transcript of, e.g., audio, discussion, video, etc. A summary of the transcript may be generated. The generation of the summary may be facilitated via large language models. Candidates that are likely (e.g., with a probability greater than a threshold) errors or inconsistencies (potentially inclusive of user or operator names) that may be present or referenced in the transcript or summary may be determined/identified using named entity recognition models. Additional sources (e.g., listings of employees, identifications of participants in a meeting, phonebooks, contact logs/records, emails, voicemails, etc.) may be consulted to provide/gain additional context. Logic (e.g., fuzzy logic) may be utilized to identify likely/probabilistic matches between the transcript or summary on the one hand and the additional sources on the other hand. For example, the logic may provide for a comparison between the transcript or summary on the one hand and the additional sources on the other hand, potentially relative to one or more thresholds. To the extent that any discrepancies are identified, corrections or clarifications may be made to the transcript or summary.

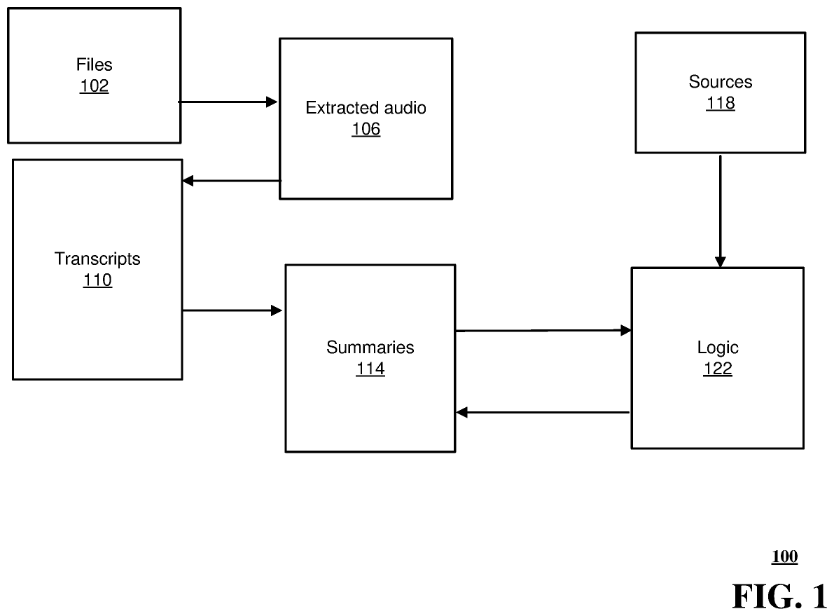

Referring now to FIG. 1, a block diagram illustrating an exemplary, non-limiting embodiment of a system 100 in accordance with various aspects described herein is shown. The system 100 may include a number of entities, such as files 102, extracted audio 106, transcripts 110, summaries 114, sources 118, and logic 122. The files 102 (which may include audio files, video files, videoconferencing files, meeting files, and the like) may be generated based on a meeting (for example). The files 102 may serve as input to a process/procedure that may generate the extracted audio 106. In some embodiments, that process/procedure may conform with one or more aspects of libraries, such as audio loading libraries.

The extracted audio 106 may serve as input to a process/procedure that may generate one or more transcripts 110, which in turn may serve as input to generate one or more summaries 114. In some embodiments, the process/procedure for generating the transcripts 110 and/or the summaries 114 may conform with, or incorporate, one or more aspects of artificial intelligence, machine learning, natural language processing (NLP), or the like. In some embodiments, the transcripts 110 and/or the summaries 114 may be generated via automatic speech recognition (ASR) techniques, such as is available via various platforms or packages that may be obtained from various sources. Of course, various customizations may be provided (relative to off-the-shelf technologies) to tailor the transcripts 110 and/or the summaries 114 for particular uses, environments, platforms, targeted users or audiences, or the like.

At least in some instances, the summaries 114 may include a reference to one or more users or operators. For example, the summaries 114 may include a reference to what is notionally the names of one or more users or operators. However, it may be the case that one or more of the names are, at least initially, misspelled in the summaries 114. It should also be kept in mind that while names are used in various examples set forth herein, there may be other terms, references, or the like that may be misspelled that may be modified or corrected in accordance with aspects of this disclosure. To demonstrate by way of example, the term “Hello” when uttered or spoken, standing alone, (1) may potentially refer to a common greeting when two people first engage one another in conversation, or (2) may refer to a business unit or entity that coincidentally happens to go by that same nomenclature. In the absence of more, it is ambiguous or unclear whether “Hello” was intended by the speaker to reference the common greeting or the business unit/entity name. Aspects of this disclosure may be utilized to resolve the ambiguity in this example (and in other instances) by utilizing contextual clues/markers surrounding the use of the subject term(s) (as potentially obtained via the sources 118 as described in further detail below).

In respect of the foregoing, the summaries 114 may be provided as input to the logic 122. The logic 122 may obtain data/information from the sources 118. In some embodiments, the sources 118 may correspond to, or be based on: listings of employees, identifications of participants in a meeting, phonebooks, contact logs/records, emails, voicemails, text messages, etc. It should be kept in mind that, in the context of a meeting (or more generally, discussion), the transcripts 110 and/or summaries 114 may encounter a name associated with a user/person that is not necessarily a participant to the meeting. For example, in the case of a meeting involving three participant users, a first of the three participants may speak about the activities of a fourth person that is not a party to the meeting. Aspects of this disclosure may be used to address inconsistencies or errors in an identification of that fourth person in the transcripts 110 or summaries 114.

The logic 122 may process the inputs that it obtains to generate outputs that may be provided to the summaries 114. For example, the outputs provided by the logic 122 may include updates or modifications to the misspellings of the names initially included in the summaries 114. The summaries 114 may be configured to obtain the outputs from the logic 122 (as an input to the summaries 114) and process the same to clarify/correct the summaries 114 by including/incorporating the updates/modifications (thereby correcting the misspellings). The logic 122 may include/incorporate phonetic fuzzy logic to facilitate the generation of the outputs from the logic 122 described above.

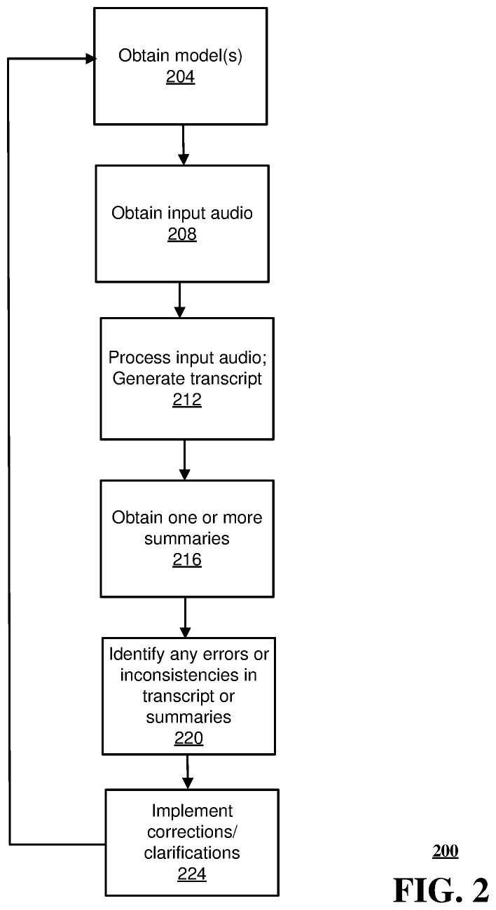

Referring now to FIG. 2, an illustrative embodiment of a method 200 in accordance with various aspects described herein is shown. In some embodiments, the method 200 may be executed, in whole or in part, in conjunction with one or more systems, devices, and/or components, such as for example the systems, devices, and components described herein. To demonstrate, aspects of the method 200 may be facilitated, in whole or in part, via a processing system that may include one or more processors. The processing system may execute instructions (that may be stored in/on a memory, a computer-readable medium or a machine-readable medium, or the like) to effectuate one or more operations. Various ones of the operations are described below in relation to the blocks shown in FIG. 2.

In block 204, one or more models may be obtained. For example, the obtaining of the model(s) as part of block 204 may include generating the model(s) and/or acquiring the model(s) (and potentially modifying one or more of the acquired model(s)). The generation or modifying of the model(s) may include providing/obtaining one or more sets of audio samples and corresponding one or more sets of text (or the like) that marries/matches the set(s) of audio samples. In this manner, and based on the provided set(s) of audio samples and text, the model(s) may be trained or adapted.

In block 208, input audio may be obtained. The obtaining of the input audio as part of block 208 may be based on a use of one or more applications. In some embodiments, the input audio may be generated via one or more recordings, as part of one or more meetings, etc.

In block 212, the input audio of block 208 may be processed. For example, the processing of block 212 may be based on an application of the input audio to one or more of the models of block 204. Based on the processing of block 212, a transcript of the input audio may be obtained. Speech-to-text technologies may be utilized as part of block 208 and/or block 212.

In block 216, one or more summaries may be obtained. For example, block 216 may include a generation of the one or more summaries based on the transcript of block 212. The summaries of block 216 may serve to highlight or emphasize particular portions of the transcript, which may be useful in a business context in terms of providing a high-level representation of the transcript for busy managers, executives, or the like. More generally, the summaries of block 216 may be obtained based on a manipulation or transformation that may be applied to the transcript of block 212. The nature of that manipulation or transformation may be selected to suit particular needs, specifications, requirements, or the like, and may, in some embodiments, be based on machine learning and/or artificial intelligence.

In block 220, the transcript of block 212 (or one or more of the summaries of block 216) may be provided as input to logic (see, e.g., logic 122 of FIG. 1) that may compare the same to one or more sources of data/information (see, e.g., sources 118 of FIG. 1). The comparison may serve to identify any potential errors or inconsistencies that may be present in the transcript or summary/summaries relative to the sources. As part of that comparison, contextual analyses may be undertaken to interpret the transcript or summary/summaries. In some embodiments, a phonetic analysis may be utilized (e.g., as part of the comparison) to determine whether a given word in a summary or transcript is pronounced significantly similar (e.g., within a threshold) to one in the (external) data source(s).

To the extent that any errors or inconsistencies are identified as part of block 220, a determination may be made whether there is a correction or clarification that is capable of being identified. To the extent that such a correction/clarification is capable of being identified, the correction/clarification may be implemented as part of a modified or revised transcript or summary/summaries, as applicable, as part of block 224.

As part of any corrections/clarifications that may be enacted/implemented as part of block 224, the model(s) of block 204 may be updated/modified to incorporate the same. In this manner, and as one of skill in the art will appreciate, aspects of the method 200 (inclusive of aspects of blocks 224 and 204) may be executed iteratively/recursively and may tend to reduce a likelihood of any errors or inconsistencies being generated the more the method 200 is utilized, which is to say that any errors or inconsistencies may tend to converge towards zero over time. This reduction in error may encourage further adoption/utilization, which may tend to increase the rate of convergence towards zero. In brief, success may drive further success.

While for purposes of simplicity of explanation, the respective processes are shown and described as a series of blocks in FIG. 2, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The various aspects of this disclosure are integrated as part of numerous practical applications. Furthermore, the various aspects of this disclosure are representative of substantial improvements to technology. Conventional approaches/technologies that add customized vocabularies/dictionaries to transcription systems/platforms have been demonstrated not to work/function appropriately/properly in all cases/scenarios since they only increase the probability that speech-to-text models will output a correct/proper spelling. In addition, such conventional approaches/technologies are often difficult to apply as part of end-to-end automatic speech recognition techniques, or for very long lists of potential matches. In sharp contrast, aspects of this disclosure may be readily and efficiently applied on/to transcripts and/or summaries, and in some embodiments may be limited to only those matches that are necessary to correct spellings in a final summary. In brief, and as demonstrated herein, the various aspects of this disclosure are not directed to abstract ideas. To the contrary, the various aspects of this disclosure are directed to, and encompass, significantly more than any abstract idea standing alone.

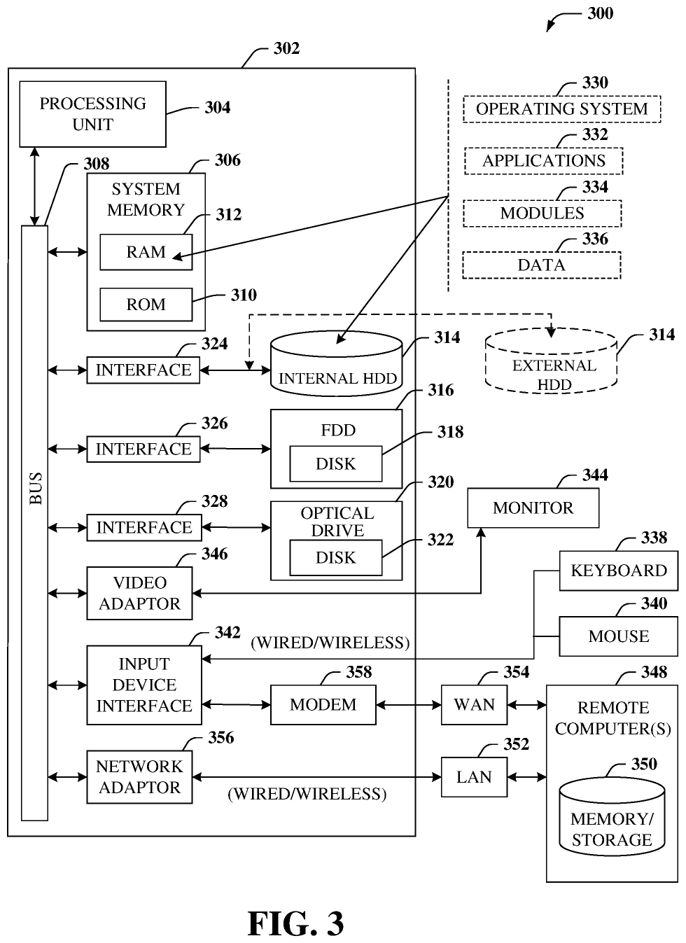

Turning now to FIG. 3, there is illustrated a block diagram of a computing environment in accordance with various aspects described herein. In order to provide additional context for various embodiments of the embodiments described herein, FIG. 3 and the following discussion are intended to provide a brief, general description of a suitable computing environment 300 in which the various aspects and embodiments of the subject disclosure can be implemented. For example, computing environment 300 can facilitate, in whole or in part, obtaining a model, obtaining input audio, processing the input audio to generate a transcript, obtaining at least one summary based on the transcript, identifying at least one error or inconsistency in the transcript or the at least one summary based on the model, and implementing, based on the identifying, a correction or a clarification in respect of the at least one error or inconsistency.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 3, the example environment can comprise a computer 302, the computer 302 comprising a processing unit 304, a system memory 306 and a system bus 308. The system bus 308 couples system components including, but not limited to, the system memory 306 to the processing unit 304. The processing unit 304 can be any of various commercially available processors. Dual microprocessors and other multiprocessor architectures can also be employed as the processing unit 304.

The system bus 308 can be any of several types of bus structure that can further interconnect to a memory bus (with or without a memory controller), a peripheral bus, and a local bus using any of a variety of commercially available bus architectures. The system memory 306 comprises ROM 310 and RAM 312. A basic input/output system (BIOS) can be stored in a non-volatile memory such as ROM, erasable programmable read only memory (EPROM), EEPROM, which BIOS contains the basic routines that help to transfer information between elements within the computer 302, such as during startup. The RAM 312 can also comprise a high-speed RAM such as static RAM for caching data.

The computer 302 further comprises an internal hard disk drive (HDD) 314 (e.g., EIDE, SATA), which internal HDD 314 can also be configured for external use in a suitable chassis (not shown), a magnetic floppy disk drive (FDD) 316, (e.g., to read from or write to a removable diskette 318) and an optical disk drive 320, (e.g., reading a CD-ROM disk 322 or, to read from or write to other high-capacity optical media such as the DVD). The HDD 314, magnetic FDD 316 and optical disk drive 320 can be connected to the system bus 308 by a hard disk drive interface 324, a magnetic disk drive interface 326 and an optical drive interface 328, respectively. The hard disk drive interface 324 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 302, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 312, comprising an operating system 330, one or more application programs 332, other program modules 334 and program data 336. All or portions of the operating system, applications, modules, and/or data can also be cached in the RAM 312. The systems and methods described herein can be implemented utilizing various commercially available operating systems or combinations of operating systems.

A user can enter commands and information into the computer 302 through one or more wired/wireless input devices, e.g., a keyboard 338 and a pointing device, such as a mouse 340. Other input devices (not shown) can comprise a microphone, an infrared (IR) remote control, a joystick, a game pad, a stylus pen, touch screen or the like. These and other input devices are often connected to the processing unit 304 through an input device interface 342 that can be coupled to the system bus 308, but can be connected by other interfaces, such as a parallel port, an IEEE 1394 serial port, a game port, a universal serial bus (USB) port, an IR interface, etc.

A monitor 344 or other type of display device can be also connected to the system bus 308 via an interface, such as a video adapter 346. It will also be appreciated that in alternative embodiments, a monitor 344 can also be any display device (e.g., another computer having a display, a smart phone, a tablet computer, etc.) for receiving display information associated with computer 302 via any communication means, including via the Internet and cloud-based networks. In addition to the monitor 344, a computer typically comprises other peripheral output devices (not shown), such as speakers, printers, etc.

The computer 302 can operate in a networked environment using logical connections via wired and/or wireless communications to one or more remote computers, such as a remote computer(s) 348. The remote computer(s) 348 can be a workstation, a server computer, a router, a personal computer, portable computer, microprocessor-based entertainment appliance, a peer device or other common network node, and typically comprises many or all of the elements described relative to the computer 302, although, for purposes of brevity, only a remote memory/storage device 350 is illustrated. The logical connections depicted comprise wired/wireless connectivity to a local area network (LAN) 352 and/or larger networks, e.g., a wide area network (WAN) 354. Such LAN and WAN networking environments are commonplace in offices and companies, and facilitate enterprise-wide computer networks, such as intranets, all of which can connect to a global communications network, e.g., the Internet.

When used in a LAN networking environment, the computer 302 can be connected to the LAN 352 through a wired and/or wireless communication network interface or adapter 356. The adapter 356 can facilitate wired or wireless communication to the LAN 352, which can also comprise a wireless AP disposed thereon for communicating with the adapter 356.

When used in a WAN networking environment, the computer 302 can comprise a modem 358 or can be connected to a communications server on the WAN 354 or has other means for establishing communications over the WAN 354, such as by way of the Internet. The modem 358, which can be internal or external and a wired or wireless device, can be connected to the system bus 308 via the input device interface 342. In a networked environment, program modules depicted relative to the computer 302 or portions thereof, can be stored in the remote memory/storage device 350. It will be appreciated that the network connections shown are example and other means of establishing a communications link between the computers can be used.

The computer 302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a model;
obtaining input audio;
processing the input audio to generate a transcript;
obtaining at least one summary based on the transcript;
identifying at least one error or inconsistency in the transcript or the at least one summary based on the model; and
implementing, based on the identifying, a correction or a clarification in respect of the at least one error or inconsistency.

2. The device of claim 1, wherein the processing of the input audio comprises using a speech-to-text technology to generate the transcript.

3. The device of claim 1, wherein the input audio is associated with a meeting or a videoconference.

4. The device of claim 1, wherein the at least one summary comprises a plurality of summaries.

5. The device of claim 4, wherein a first summary of the plurality of summaries and a second summary of the plurality of summaries are different from one another based on the first summary being targeted to a first audience and the second summary being targeted to a second audience that is different from the first audience.

6. The device of claim 1, wherein the at least one error or inconsistency is included in the transcript.

7. The device of claim 1, wherein the at least one error or inconsistency is included in the summary.

8. The device of claim 1, wherein the operations further comprise:
modifying, based on the implementing, the model, resulting in a modified model.

9. The device of claim 8, wherein the operations further comprise:
obtaining second input audio;
processing the second input audio to generate a second transcript;
obtaining a second least one summary based on the second transcript; and
identifying a second at least one error or inconsistency in the second transcript or the second at least one summary based on the modified model.

10. The device of claim 1, wherein the obtaining of the model comprises generating the model.

11. The device of claim 10, wherein the generating of the model comprises training the model based on a first set of audio samples and a second set of text corresponding to the first set of audio samples.

12. The device of claim 1, wherein the obtaining of the input audio comprises extracting the input audio from at least one file.

13. The device of claim 1, wherein the at least one error or inconsistency corresponds to a misspelling of a name.

14. The device of claim 13, wherein the name corresponds to a person.

15. The device of claim 1, wherein the identifying of the at least one error or inconsistency in the transcript or the at least one summary is further based on data or information obtained from at least one source.

16. The device of claim 15, wherein the at least one source is based on: listings of employees, identifications of participants in a meeting, phonebooks, contact logs, emails, voicemails, text messages, or any combination thereof.

17. A non-transitory machine-readable medium, comprising executable instructions that, when executed by a processing system including a processor, facilitate performance of operations, the operations comprising:
obtaining audio;
processing the audio to generate a transcript;
obtaining at least one summary based on the transcript;
identifying at least one error in the at least one summary based on a model; and
implementing, based on the identifying, a correction in respect of the at least one error.

18. The non-transitory machine-readable medium of claim 17, wherein the at least one error includes a plurality of errors, wherein a first error of the plurality of errors corresponds to a name of a person, and wherein a second error of the plurality of errors corresponds to a name of a business or entity.

19. A method, comprising:
obtaining, by a processing system including a processor, audio;
processing, by the processing system, the audio to generate a transcript;
identifying, by the processing system, at least one error in the transcript based on a model and data obtained from a plurality of sources; and
implementing, by the processing system and based on the identifying, at least one correction in respect of the at least one error.

20. The method of claim 19, wherein the implementing of the at least one correction comprises modifying a plurality of names included in the transcript, the modifying resulting in a modified transcript.
